(19) United States
(12) Patent Application Publication
(10) Pub. No.: US 2014/0108113 A1
(43) Pub. Date: Apr. 17, 2014

(54) EMPLOYEE INCENTIVE AND COMPENSATION SYSTEM

(71) Applicant: Jetz Convenience Centers, Hales Corners, WI (US)

(72) Inventors: Robert M. O'Connor, Mukwonago, WI (US); Timothy J. Klein, Elm Grove, WI (US)

(73) Assignee: Jetz Convenience Centers, Hales Corners, WI (US)

(21) Appl. No.: 14/054,956

(22) Filed: Oct. 16, 2013

Related U.S. Application Data
(60) Provisional application No. 61/715,006, filed on Oct. 17, 2012.

(51) Int. Cl. G06Q 30/02

(52) U.S. Cl. CPC G06Q 30/0214; G06Q 30/0238
USPC 705/14.16

(57) ABSTRACT

A system for motivating employees to increase sales in a retail environment and for compensating the employees accordingly is disclosed. A customer presents products for purchase and may further be identified according to a customer loyalty program. The system identifies existing promotions in which the customer may be interested as a function of the products selected for the current purchase and according to the customer's past purchase history. A script is provided to the employee to be read to the customer to inform the customer of the existing promotion. In addition, the value of a potential commission to be earned is presented to the employee to motivate the employee to read the script to the customer. If the customer takes advantage of the promotion, the commission is awarded to the employee.

### CROSS-REFERENCE TO RELATED APPLICATIONS

This application claims priority to U.S. provisional application Ser. No. 61/715,006, filed Oct. 17, 2012, the entire contents of which is incorporated herein by reference.

### BACKGROUND OF THE INVENTION

The subject matter disclosed herein relates to a system to provide incentives to employees and to determine employee compensation.

As is known to those skilled in the art, retail environments utilize many different techniques to maximize sales, including, but not limited to, customer loyalty programs, coupons, sales, and periodic promotions. Further, many different techniques are utilized to provide notice of the sales, promotions, etc., including, but not limited to, newspaper advertisements, direct mailings, emails, and in-store signage. Despite the numerous advertising channels, the potential exists for a customer to be unaware of a particular promotion. In addition, in certain retail markets it is not cost-effective to advertise sales beyond in-store signage. Thus, it is desirable to provide a system to alert customers to existing promotions when they arrive at the retail location.

However, simply alerting a customer to existing promotions at a retail location is not without its drawbacks. Various systems have been employed such as providing racks of sales circulars, display monitors that cycle through a list of promotions, and signage proximate to the merchandise on which the promotion exists. However, each of the afore-mentioned systems requires that the customer observe a particular promotion, either by reviewing the circular, viewing the monitor at the proper time, or passing by the particular merchandise. While the customer may be persuaded to purchase the merchandise if the promotion is observed, the retail location may lose a sale if the promotion is not observed.

As a result, efforts have been made to provide targeted promotions to customers. In some retail locations, a computer executing point of sale software is used to process customer transactions. The computer may store the transaction information or transmit the transaction information to another device for storage. On subsequent visits to the retail location, the point of sale software may access the customer's transaction history and identify existing promotions that correspond to the customer's past transactions. The point of sale software may analyze the current transaction information and identify existing promotions corresponding to the pending transaction of which the customer may be unaware.

The success of such systems, however, typically requires participation by employees. Although, a targeted promotion may be displayed at a check out station, customers may either be distracted by other items at the check out station or simply not recognize that the promotion relates to the product they are purchasing. However, the quality of employees and the desire of employees to participate in suggestive sales can vary significantly. While some employees willingly participate and may excel at suggestive sales, other employees may not wish to participate or may be poor sales personnel. Thus, it would be desirable to provide an incentive system to motivate all employees to participate and to provide all employees the opportunity to perform at a high level.

### BRIEF DESCRIPTION OF THE INVENTION

The subject matter disclosed herein describes a system for motivating employees to increase sales in a retail environment and for compensating the employees accordingly. A customer presents products for purchase and may further be identified according to a customer loyalty program. The system identifies existing promotions in which the customer may be interested as a function of the products selected for the current transaction and according to the customer's past purchase history. A script is provided to the employee to be read to the customer to inform the customer of the existing promotion. In addition, the value of a potential commission to be earned is presented to the employee to motivate the employee to read the script to the customer. If the customer takes advantage of the promotion, the commission is awarded to the employee. In addition, a running total of the employee's commission and a current rank of the employee's sales with respect to other employees are maintained over a predefined time period, such as one pay period. The running total and current rank of the employee are displayed to the employee to motivate the employee to participate in the suggestive sale system.

According to one embodiment of the invention, a method for rewarding employee performance in a retail environment is disclosed. The method includes the steps of entering data in a point of sale terminal, where the data identifies at least one product to be purchased by a customer at the retail environment, and transmitting the data identifying the at least one product from the point of sale terminal to a server. Details of at least one promotion stored in the server are identified as a function of the data identifying the at least one product, and the details of each promotion include a script for an employee of the retail environment to present the promotion to the customer. The details of the at least one promotion are transferred from the server to the point of sale terminal, and the script is displayed at the point of sale terminal such that the script is visible for the employee to present to the customer. When the customer decides to purchase at least one additional product as a result of the employee presenting the script to the customer, the employee enters data identifying the at least one additional product to be purchased by the customer in the point of sale terminal and the data is recorded in the server. The employee is rewarded for each additional product purchased by the customer as a result of the employee presenting the script to the customer.

According to another aspect of the invention, the method may include an initial step of displaying a prompt on the point of sale terminal for the employee to inquire whether the customer is enrolled in a loyalty program for the retail environment. When the customer is not enrolled in the loyalty program, a script is displayed at the point of sale terminal for the employee to promote the loyalty program to the customer. When the customer is enrolled in the loyalty program, the method further includes the steps of receiving an identification number from the customer corresponding to the loyalty program, retrieving a purchase history stored in the server corresponding to the identification number, and identifying details of at least one promotion stored in the server as a function of the purchase history.

According to still other aspects of the invention, the details of the at least one promotion also include a potential commission to be earned by the employee when the customer decides to purchase the at least one additional product as a result of the employee presenting the script to the customer. The potential commission may be displayed to the employee on the point of sale terminal in tandem with displaying the script. The server may also store a running total of commissions earned for each employee and add the potential commission to the running total for the employee when each additional product is purchased by the customer. The server may store thresholds which define a level at which the employee receives a bonus. The bonus is awarded when the running total of commissions for the employee is equal to or greater than the threshold. The threshold and the running total may also be displayed to the employee on the point of sale terminal while the employee is working. The server may also determine a rank of the employee with respect to at least one other employee of the retail environment as a function of the running total of commissions for the employee and the running total of commissions for each of the other employees. The rank may also be displayed on the point of sale terminal to the employee while the employee is working.

According to another aspect of the invention, the commission awarded to the employee may be reduced by poor performance. For example, the server may maintain a record of the accuracy of the employee in maintaining a cash drawer and adjust the running total of commissions as a function of the accuracy. According to still another aspect, a prompt may be provided to the customer on a customer display to provide feedback on a quality of service provided to the customer by the employee of the retail environment. The feedback is transmitted from the customer display to the server and the running total of commissions for each employee is adjusted as a function of the feedback provided by the customer.

According to another embodiment of the invention, a system for determining employee compensation in a retail environment includes a retail check out station operated by an employee to receive data identifying at least one product to be purchased by a customer. The retail check out station includes a monitor configured to display data to the employee and a server in communication with the retail check out station. The server includes a storage device configured to store a plurality of customer records for a loyalty program for the retail environment and a processor configured to receive from the retail check out station the data identifying the at least one product to be purchased by the customer and identify details of at least one promotion stored in the storage device as a function of the data identifying the at least one product. The details of each promotion include a script for the employee of the retail environment to present the promotion to the customer. The processor transmits the details of the at least one promotion from the server to the retail check out station for display to the employee, receives from the retail check out station data identifying at least additional one product purchased by the customer corresponding to the at least one promotion, and rewards the employee for each additional product purchased by the customer.

According to another aspect of the invention, the script for the employee may be displayed on the monitor of the retail check out station for the employee to present to the customer. Optionally, the script for the employee is displayed on a script monitor in communication with the retail check out station for the employee to present to the customer.

According to still other aspects of the invention, the system includes a customer monitor in communication with the retail check out station configured to display visual data to the customer. The details of each promotion may also include a product and a price which are displayed on the customer monitor. The system may also include a loyalty program device scanner configured to read an identification number from a loyalty program device provided to the customer. The identification number is transmitted to the server and the processor is further configured to retrieve a purchase history stored in the storage device corresponding to the identification number and identify details of at least one promotion stored in the storage device as a function of the purchase history.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is an exemplary retail environment incorporating one embodiment of the invention;

FIG. 2 is a block diagram representation of an exemplary retail environment incorporating one embodiment of the invention;

FIG. 3 is an exemplary kiosk illustrated in FIG. 2;

FIG. 4 is an exemplary counter-top electronic device illustrated in FIG. 2;

FIG. 5 is an exemplary fuel pump illustrated in FIG. 2;

FIG. 6 is a block diagram representation of an electronic device incorporating one embodiment of the present invention;

FIG. 7 is a flowchart illustrating steps in determining an employee's compensation according to one embodiment of the present invention; and

FIG. 8 is a flowchart illustrating steps in providing an employee with scripts to present suggestive sales according to one embodiment of the present invention.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

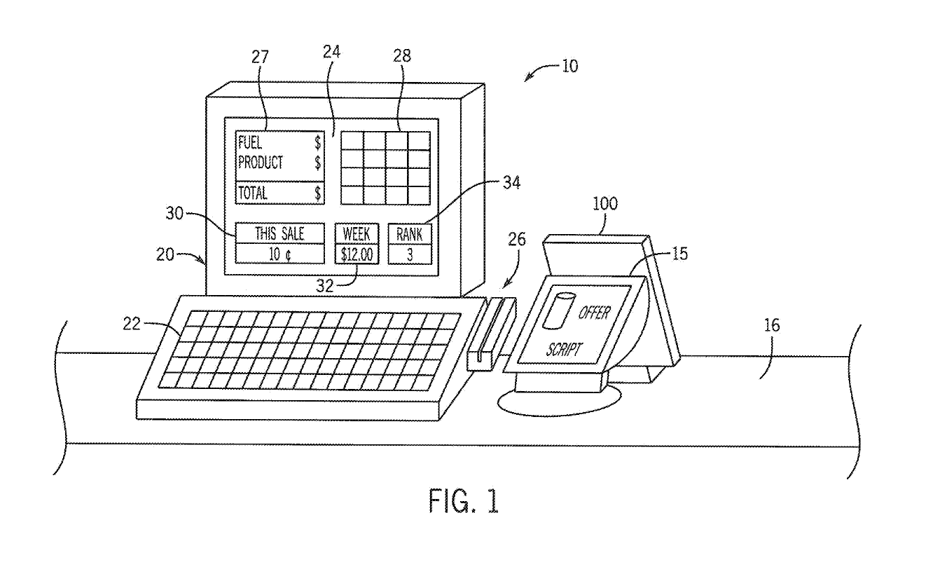

Turning initially to FIG. 1, an exemplary retail check out station 10 is illustrated. The check out station 10 includes a point of sale terminal 20, customer monitor 100, and a script monitor 15, each configured to rest on a counter 16 in the retail location. The point of sale terminal 20 includes, for example, a keypad 22 and a monitor 24. The keypad 22 is typically customized according to the products offered for sale at the retail location to facilitate processing of a customer's transaction. Similarly, the monitor 24 is configured to display information relevant to the products offered at the retail location. It is further contemplated that the monitor 24 may include a touch screen interface and may display a product selection window 28 which works in cooperation with, or even replaces, the keypad 22. The point of sale terminal 20 also includes a card reader 26. The card reader 26 may be configured to read magnetic strips on cards, such as credit cards, debit cards, gift cards, or customer loyalty cards.

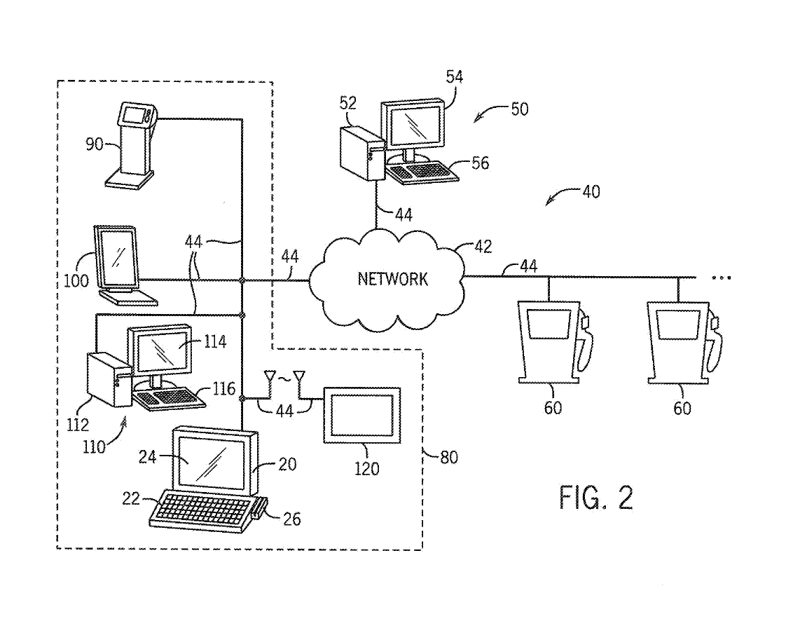

The retail check out station 10 is typically one component of a larger retail environment. Referring next to FIG. 2, an exemplary retail environment 40 for a convenience store including fuel products for sale outside a store 80 and non-fuel products for sale within the store 80 is illustrated. The retail environment 40 includes a network 42 which may include the Internet, an intranet, or a combination thereof. Network media 44 establish communication between devices connected to the network 42. The network media 44 may include wired connections, wireless connections, or a combination thereof. A central server 50 is connected to the network 42 and includes at least one processing unit 52, a monitor 54, and a user interface 56 such as a keyboard. The central server 50 may be located within the store 80 or, alternately and as illustrated, may be located at a location remote from the store 80. At least one fuel pump 60 is connected to the network 42 outside the store 80, and multiple devices are connected to the network 42 within the store 80. The devices connected to the network 42 within the store may include, but are not limited to: a kiosk 90; a customer monitor 100; a computer station 110 having a processing unit 112, a monitor 114, and a user interface such as a keyboard 116; a point of sale terminal 20; a tablet computer 120, or various combinations thereof.

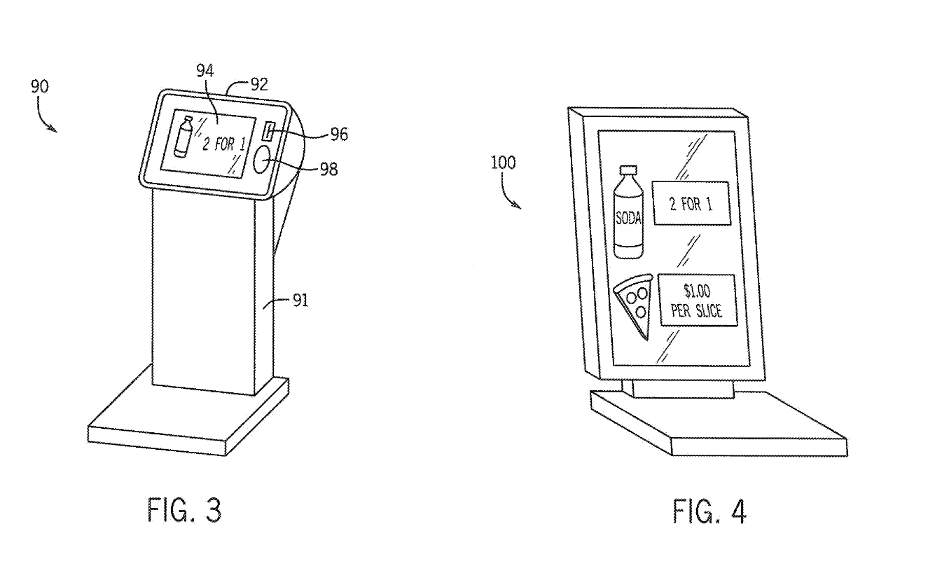

Referring next to FIG. 3, the kiosk 90 includes a processing unit 92 mounted on a stand 91. The kiosk 90 may be located anywhere within the store 80, but is preferably at a high traffic location such as the entrance or proximate to the check out station 10. The kiosk includes a display 94 to provide information to the customer and may include a magnetic strip card reader 96 and/or a near-field communication (NFC) or radio frequency identification (RFID) reader 98.

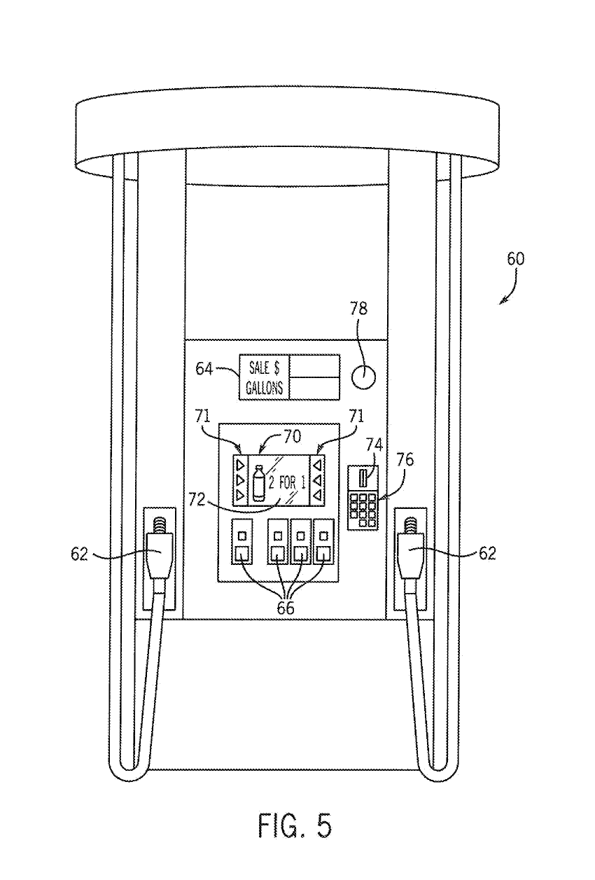

Referring next to FIG. 5, the fuel pump 60 includes one or more nozzles 62 configured to dispense fuel. A display unit 64 provides a visual indication of the amount of fuel dispensed and the corresponding cost for each transaction. Selection buttons 66 allow the customer to select a desired grade and/or type of fuel to dispense from the fuel pump 60. A processing unit 70 is mounted in the fuel pump 60 and includes a display 72. The display 72 may include a plurality of selection buttons 71 oriented along each side of the display 72 to select options presented on the display 72. The fuel pump further includes a magnetic strip card reader to read, for example, credit cards, debit cards, or gift cards for payment or customer loyalty cards to identify the customer. A keypad 76 may allow the customer to enter further information, for example to confirm identity or to respond to a prompt on the display 72. Optionally, a customer may be provided with an NFC device that may be positioned proximate to an NFC reader 78 included in the fuel pump 60 to identify the customer.

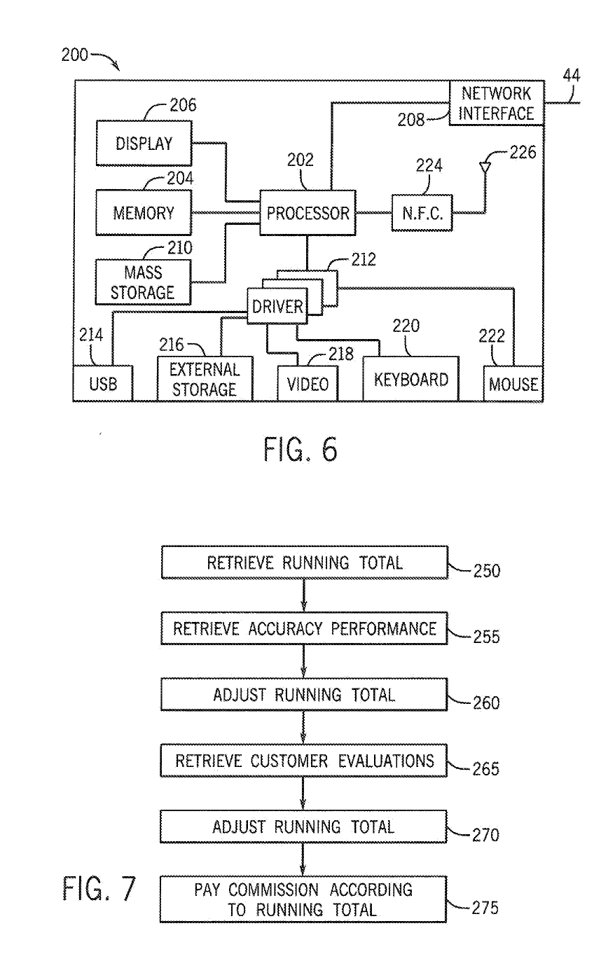

Turning next to FIG. 6, an exemplary processing unit 200 is illustrated. The exemplary processing unit 200 is representative of the various processing units (e.g., 52, 70, 92, 112) and other devices such as the point of sale terminal 20, customer monitor 100, tablet computer 120 discussed above. Although each of the processing units (52, 70, 92, 112) or other devices (20, 100, 120) may incorporate only a portion of the elements shown in the exemplary processing unit 200, each of the devices includes a processor 202 and a memory device 204 in communication with the processor 202. It is contemplated that the processor 202 may be a single device or multiple devices operating separately or in parallel as is understood in the art. Further, each processor 202 may be a microprocessor, a field programmable gate array (FPGA), application specific integrated circuit (ASIC), a logic circuit, or a combination thereof. Each memory device 204 includes one or more devices operating separately or as a single memory unit. The memory device 204 may be persistent, non-persistent, or a combination thereof. The memory device 204 stores a series of instructions, or programs, executable by the processor 202. Each of the processing units (52, 70, 92, 112) or other devices (20, 100, 120) further includes a network interface 208 to connect the processor 202 with the network 42 via the network media 44.

According to the application requirements, each of the processing units (52, 70, 92, 112) or other devices (20, 100, 120) may include one or more of the following components as discussed with respect to the exemplary processing unit 200. A display 206 is integrated in the exemplary processing unit 200. Optionally, the exemplary processing unit 200 may include a video port 218 to provide a connection to an external monitor. A mass storage device 210, such as a magnetic storage device or flash memory, is included in the exemplary processing unit 200. The mass storage device 210 stores, for example, an operating system and application software configured to execute the steps required by the system to motivate employees to increase sales and to maintain a sales record to compensate employees accordingly. The mass storage device 210 may also be used to store other data, such as the details of existing promotions, loyalty program records, records of past customer transactions, and/or employee performance and compensation records according to the system requirements. A plurality of device drivers 212 may also be stored on the mass storage device 210. These device drivers 212 may be executed directly from the mass storage device 210 by the processor 202 or first copied to the memory device 204 to provide faster execution. Each device driver 212 controls execution of a device connected to the exemplary processing unit 200. The devices may include, but are not limited to, a universal serial bus (USB), an external storage device 216, for example, a CD-ROM or DVD-ROM drive, a video port 218, a keyboard or keypad 220, or a mouse 222. The exemplary processing unit 200 may also include an NFC reader 224 connected to an antenna 226. The antenna 226 may be internal or external to the exemplary processing unit 200.

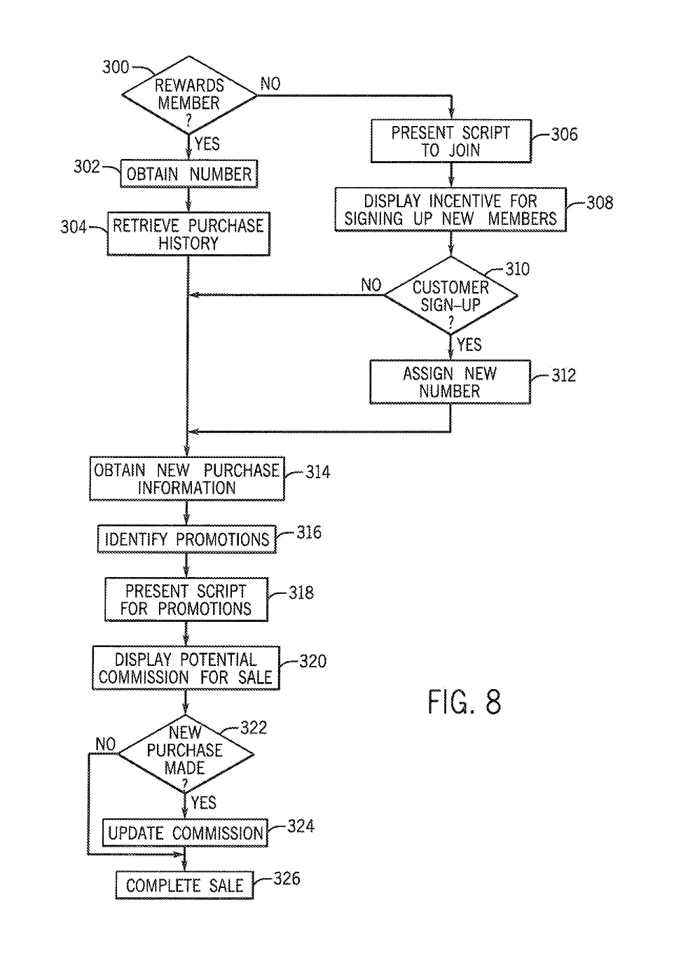

To facilitate understanding of the operation of the incentive system, an exemplary transaction is described with reference primarily to FIGS. 1, 2, and 8. A customer arrives at the retail location 40. The customer may dispense fuel to a vehicle from a fuel pump 60 and/or select additional merchandise to be purchased during the transaction from within the store 80. The fuel pump 60 communicates the amount of fuel dispensed to the point of sale terminal 20 and the customer brings the additional merchandise to the check out station 10. Prior to initiating the transaction, the point of sale terminal 20 prompts the employee to ask the customer whether they belong to the retail location's customer loyalty, or customer rewards, program, as shown in step 300. If the customer is a loyalty program member, the employee obtains the customer's identification number, as shown in step 302. The identification number may be encoded, for example, in a magnetic strip on a card that may swiped through the card reader 26. Optionally, the identification number may be stored on an NFC device that is passed in front of an NFC reader to retrieve the identification number. As still another option, the employee may retrieve the identification number from a database of loyalty program records stored, for example, on the central server 50 or on a local computer station 110 via the customer's name, address, telephone number, or other personal information linked to the identification number. At step 304, having retrieved the customer's identification number, the point of sale terminal 20 retrieves the customer's purchase history.

If the customer is not a loyalty program member, the employee, at step 306, is provided a script, displayed on the script monitor 15, to read to the customer inviting the customer to join the loyalty program. In addition, the incentive system may be configured to provide the employee with a bonus for each new customer that joins the loyalty program. At step 308, this bonus is displayed in an incentive window 30 on the POS monitor 24. The bonus encourages the employee to read the script to the customer rather than bypassing the step in each transaction, and the visual indication in the incentive window 30 reminds the employee of the bonus during each transaction. If the customer agrees to join the loyalty program, the employee enters the customer's agreement on the POS terminal 20 and a new identification number is assigned to the customer, as shown in steps 310 and 312. If the customer declines to join the loyalty program, the transaction continues at step 314.

At step 314, the employee obtains the product information for the current transaction. This may include, for example, scanning a Universal Product Code (UPC), identifying a fuel pump 60 used by the customer, entering a code, pressing buttons designated for specific merchandise on the POS keypad 22, or otherwise entering information to identify merchandise to be purchased during the pending transaction. A transaction window 27 displays a list of merchandise for the pending transaction on the monitor 24.

At step 316, the POS terminal 20 identifies promotional offers in which the customer may be interested. The promotional offers are identified, for example, as a function of the merchandise to be purchased during the pending transaction or, if the customer was an existing loyalty program member, as a function of the customer's purchase history. The promotional offers are displayed on the script monitor 15 along with a script for the employee to read, as shown at step 318. According to other embodiments of the invention, the script monitor 15 may be integrated into the POS terminal 20 and scripts may be presented, for example, in a script window on the monitor 24. The promotional offer may also be displayed on the customer monitor 100. Providing promotional offers to customers in this manner is sometimes referred to as a suggestive sale or an up-sale. The incentive system is configured to provide the employee with a commission for each successful suggestive sale, and the amount of the commission may be determined, for example, on a flat rate basis or on a percentage basis for each promotional offer. At step 320, the amount of the potential commission is displayed in the incentive window 30 on the POS monitor 24. Displaying the potential commission encourages the employee to read the script to the customer rather than bypassing the step in each transaction, and the visual indication in the incentive window 30 reminds the employee of the commission during each transaction. If the customer purchases the product, the employee adds the new product to the pending transaction, the commission from the new product is added to a running total maintained for the employee, and the transaction is completed, as shown in steps 322, 324, and 326. The incentive system may be configured to maintain the running total over any desired time period, including, but not limited to, an employee's shift, a pay period (e.g., weekly or bi-weekly), or monthly. If the customer declines to purchase the promotional product, the employee simply completes the original transaction, as shown in steps 322 and 326.

It is further contemplated that the customer may be provided the opportunity to rate each experience at the retail location. At the end of each transaction, a prompt may be displayed on the customer monitor 100 requesting the customer rate the experience. According to one embodiment of the invention, the customer is provided three options, negative, neutral, or positive. Optionally, a scale, for example, from 1 to 5 or from 1 to 10 may be presented to the customer. The simple format is designed to encourage the customer to respond and to require a minimal time commitment such that a customer does not create an undesirable delay for subsequent customers in line. Optionally, more detailed feedback may be provided, for example, at a free-standing kiosk 90 positioned at a distance from the check out station 10, enabling a customer to provide additional feedback about an especially positive or negative experience. The customer feedback may be stored and correlated to a specific employee working at the location, to a team of employees working at the location, or to the location in general.

Referring next to FIG. 7, the incentive system may utilize additional factors to make a final determination of an employee's commission. The additional factors are performance related and reward employees for outstanding performance and penalize employees for inferior performance. At the end of each pay period, a final commission is determined by first retrieving the running total of the employee's commission over the corresponding pay period, as shown at step 250. At step 255, an evaluation of the employee's accuracy at managing the cash drawer in the point of sale terminal 20 is retrieved. The accuracy performance is determined by the number and magnitude of overages and shortages in the cash drawer during the pay period. For example, if the cash drawer of an employee is under or over by 50¢ one day no penalty may be assessed, but it the employee is under or over by $5.00 on one day, the employee's commission may be reduced by a predefined amount. Similarly, if the employee is under or over by 50¢ multiple times during the pay period, the employee's commission is similarly reduced. At step 260, the running total of the employee's commission is adjusted according to the accuracy performance.

The employee's commission may similarly be adjusted according to customer evaluations. At step 265, a history of customer evaluations is retrieved. As previously indicated, the incentive system may be configured to correlate customer reviews of their shopping experience to a particular employee, a group of employees, or the entire location. Similarly, the impact of the customer evaluations on the employee's commission may be configured based on the various correlations. For example, evaluations directly tied to an employee may have a greater impact than group evaluations. Further, the incentive system may be configured to detect trends in customer reviews during periods in which an employee works. If the trend is mixed, it may indicate that both negative reviews and positive reviews are less impacted by the specific employee. If however, trends lean either positive or negative, the indication may be that the trend is more directly impacted by that employee. At step 270, the running total of the employee's commission is adjusted according to the customer evaluations. At step 275, the adjusted total of the running commission is then paid to the employee at the end of each pay period.

The customer feedback may also be directed generally to the retail location 40 rather than a particular employee. An application executing on the kiosk 90 may ask the customer to rank the store, for example, based on overall cleanliness, the appearance of the restrooms or employee uniforms, or overall level of customer service. Each retail location 40 may be assigned an index corresponding to a composite value of customer evaluations. The index may be applied to all employees at the location to either increase or decrease each of the employees' commissions. The store index fosters a team environment in which employees are accountable to each other for the overall performance of the retail location 40. Further, the server 50 may store an ongoing value of the index for each retail location 40. Employees may be rewarded also based on trends in the store index. For example, even if the overall index is low, but an upward trend is occurring, employees' commissions may remain the same rather than being reduced. Conversely, if the overall index is high, but a downward trend is occurring, employees' commissions may remain the same rather than being increased.

One feature of the present system is to provide motivation to employees to actively participate in the incentive system. As a primary motivator, the more successful the employee is in making the promotional sales, the larger the commission the employee will receive. In addition to the incentive window 30 previously discussed, which is designed to encourage an employee to participate on a per transaction basis, a total commission window 32 and/or a rank window 34 may be displayed on the POS monitor 24. The total commission window 32 displays the running total of an employee's commission during the desired time period. The rank window 34 compares the employee to the other employees at the retail location. The running total and rank may be used to present still additional motivation for an employee's to offer the promotional sales. For example, the incentive system may be configured to provide certain thresholds to achieve bonus compensation. The thresholds may be defined according to certain numbers of successful promotional sales or certain amounts of commission during a time period. If an employee either reaches the threshold, the employee receives bonus compensation. Multiple threshold levels may be established with varying levels of bonuses awarded at each level. The incentive system may be configured to present additional windows on the POS monitor 24 displaying these threshold levels and the progress of the employee in obtaining each level.

It is further contemplated that an employee may configure and/or select their own incentive windows 30 for display on the monitor 24. An employee may choose to challenge another employee to see who can achieve the highest commission. The incentive window 30 may provide a running total of both employees' commissions. Optionally, an employee may decide to beat a prior day's commission or to reach a personal best commission. The incentive window 30 may display the running total and the selected target. It is contemplated that the incentive system may be configured to provide a selection menu from which the employee may select a preconfigured incentive window 30 or provide a list of formats and/or targets in which to present the incentive window 30. By providing various targets and formats in which to present incentives, each employee may select a format that is engaging to them or select varying formats to maintain enthusiasm for the incentive system.

According to still another aspect of the invention, employees may be awarded points in addition to monetary commissions. While commissions may be paid regularly (e.g., each pay period, monthly, quarterly, etc. . . . ) the points may be stored for an extended period or even indefinitely as long as an employee is employed at the retail location 40. A prize list may be established where each prize requires a certain number of points for redemption. Prizes may vary from gift cards to local merchants to new vehicles with appropriate point levels assigned to the value of prizes.

The motivation for employees to actively participate in the incentive system may also be based on location-wide incentives and/or deductions. The incentives may be established on a competitive basis between employees at a location. For example, an employee may receive a bonus based on the rank of the employee with respect to other employees at the location at the end of a certain time period, whether it is monthly, quarterly, or on an annual basis. This will motivate the employee to increase the number of successful promotional sales, thereby increasing the employee's rank. Alternately, the incentives may be established on a team basis, establishing target thresholds for each team and/or for the entire retail location. If the combined performance of the employees in a team or at a location exceeds the target threshold, then each of the employees will receive a bonus. Thus, employees will be motivated to encourage each other to participate in the incentive system. A location wide deduction may occur, for example, if a systemic problem is identified at a retail location, such as employees swiping each other in if one is running late, failing to maintain a desired appearance or cleanliness of the location, or other systemic violations of an employee handbook. The deduction may be tiered such that the commission owed to a manager is reduced by a greater amount than the reduction of other employees. However, the location-wide deduction encourages every employee to report and/or take steps to correct such problems. The incentive system may be configured to present additional windows on the POS monitor 24 displaying these additional group threshold levels and the progress of the employees in obtaining each level.

Another feature of the present system is to provide employees with the ability to successfully offer the promotional sale. As previously discussed, different employees have varying ability to pitch the promotional offers to customers. By providing scripts on a display, each employee is provided with a specific pitch to present to the customer. The scripts may be developed via input, for example, from top performing employees and/or professional marketing personnel. Thus, every employee is provided with a script to increase the percentage of successful sales.

According to one embodiment of the invention, the central server 50 is configured to store, among other things, customers' identification information, purchase histories, loyalty/reward membership, employee scripts, and a list of existing promotions. Each of the devices at the retail location that are connected via the network 42 may be configured to access and/or update the stored information in the central server 50 as appropriate. The central server 50 may be located remotely from the store 80 or may be incorporated into a computer station 110 within the store 80.

As another aspect of the invention, a promotion manager module may be executing on the central server 50 or on a computer station 110 within the store 80. The promotion manager module maintains the list of active promotions and monitors numerous variables to identify one or more promotions to present to the customer. As previously discussed, a customer's past transaction history may identify products in which the customer would be interested in purchasing. Similarly, the products selected for the present transaction may trigger relevant promotions. However, additional factors such as the weather forecast or the actual weather for the day may be used to select a specific promotion. For example, if it is hot and sunny, a beverage promotion may be selected over another promotion. Alternately, if the weather is above-freezing during the winter, a car-wash promotion may be selected over another promotion. Similarly, the time of day may be used to select a promotion. During the morning commute, a coffee promotion may be selected, and over the lunch hour, a sandwich promotion may be selected. It is contemplated that the promotion manager module may be configured to include numerous other variables to weigh which promotion is selected to present to a customer. In addition, the promotion manager module may be configured to present a single promotion or multiple promotions sequentially to the customer.

The present invention is discussed above with respect to one embodiment of the invention. It is further contemplated that numerous configurations and combinations of the devices discussed above may be utilized without deviating from the scope of the invention. For example, the processing unit 70 on the fuel pump 60 may include a speaker. Prior to or as a customer is dispensing fuel from the pump 60, the customer may swipe a loyalty/reward card through the card reader 74 or pass an loyalty/reward NFC device in front of the NFC reader 78 to input the customer's loyalty/reward identification number. The processing unit 70 at the fuel pump may retrieve the customer's purchase history and identify existing promotions as a function of the purchase history. The existing promotions and a script may similarly be displayed to an employee inside the store 80 on a script monitor 15. The employee may read the script to the customer as the fuel is still being dispensed to alert the customer to an existing promotion in which they may be interested. Further, any device capable of being connected to the network 42 may be employed. For example, an application executable on the customer's smart phone may be provided to the customer upon joining the loyalty program. When the customer is at one of the retail locations, promotions may be delivered to the application on the smart phone and presented either visually on the display screen or audibly via the speaker.

According to another embodiment of the invention, employees may work in a retail location which requires mobile employees, such as wait staff at a restaurant or sales personnel in a department store. It is contemplated that the above-discussed system may be implemented for mobile employees via a tablet computer. If the restaurant or department store includes a loyalty program, the employee may first obtain the customer's loyalty identification number or invite the customer to join the program. The tablet computer may communicate with the remote server to retrieve the customer's purchase history and identify existing promotions in which the customer may be interested as a function of their purchase history. If the retail location is a restaurant, a member of the wait staff may enter the order for a customer at the restaurant in the tablet computer. If the retail location is a department store, the sales personnel may entire merchandise in which the customer is interested in purchasing into the tablet computer. In either case, the tablet computer may retrieve additional promotions as a function of the customer's order or selected merchandise. Scripts and potential commissions corresponding to the promotional offers may be transmitted to the tablet computer for display to the employee on the monitor of the tablet computer.

According to another embodiment of the invention, the employee incentive system may include a two-tier commission system. Each employee may receive a commission at a first level for every item sold. The employee may then receive a commission at a second level for every promotional item sold. For example, sales of soda products, generally, may result in a 5¢ per item or a 1% commission. However, on a selected day or during a selected week, a vendor may provide an incentive to the store to increase sales of their soda. A promotional script is generated and employees may receive a 10¢ per item or a 2% commission on all soda products for the specified vendor. As further incentive to the employee to present the script to the customer, the employee may receive a reduced commission or no commission for sales of competing soda products during the promotional period.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method for rewarding employee performance in a retail environment, comprising the steps of:
entering data in a point of sale terminal, the data identifying at least one product to be purchased by a customer at the retail environment;
transmitting the data identifying the at least one product from the point of sale terminal to a server;
identifying details of at least one promotion stored in the server as a function of the data identifying the at least one product, wherein the details of each promotion include a script for an employee of the retail environment to present the promotion to the customer;
transmitting the details of the at least one promotion from the server to the point of sale terminal;
displaying the script at the point of sale terminal, wherein the script is visible for the employee to present to the customer;
when the customer decides to purchase at least one additional product as a result of the employee presenting the script to the customer, entering data identifying the at least one additional product to be purchased by the customer in the point of sale terminal;
recording the data identifying the additional product purchased by the customer in the server; and
rewarding the employee for each additional product purchased by the customer as a result of the employee presenting the script to the customer.

2. The method of claim 1 further comprising an initial step of displaying a prompt on the point of sale terminal for the employee to inquire whether the customer is enrolled in a loyalty program for the retail environment.

3. The method of claim 2 further comprising the step of displaying a second script at the point of sale terminal for the employee to promote the loyalty program to the customer when the customer is not enrolled in the loyalty program.

4. The method of claim 2 wherein when the customer is enrolled in the loyalty program the method further comprises the steps of:
receiving an identification number from the customer corresponding to the loyalty program;
retrieving a purchase history stored in the server corresponding to the identification number; and
identifying details of at least one promotion stored in the server as a function of the purchase history.

5. The method of claim 1 wherein the details of the at least one promotion further include a potential commission to be earned by the employee when the customer decides to purchase the at least one additional product as a result of the employee presenting the script to the customer, the method further comprising the step of displaying the potential commission to the employee on the point of sale terminal in tandem with displaying the script.

6. The method of claim 5 further comprising the steps of:
storing a running total of commissions earned for each employee on the server; and
adding the potential commission to the running total for the employee when each additional product is purchased by the customer.

7. The method of claim 6 further comprising the step of storing at least one threshold in the server, the threshold defining a level at which the employee receives a bonus when the running total for the employee is equal to or greater than the threshold.

8. The method of claim 7 further comprising the step of displaying the threshold and the running total to the employee on the point of sale terminal while the employee is working.

9. The method of claim 6 further comprising the step of determining a rank of the employee with respect to at least one other employee of the retail environment as a function of the running total for the employee and the running total for each of the other employees.

10. The method of claim 9 further comprising displaying the rank on the point of sale terminal to the employee while the employee is working.

11. The method of claim 6 further comprising the steps of:
determining an accuracy of the employee in maintaining a cash drawer; and
adjusting the running total as a function of the accuracy.

12. The method of claim 6 further comprising the steps of:
providing a prompt to the customer on a customer display to provide feedback on a quality of service provided to the customer by the employee of the retail environment;
transmitting the feedback from the customer display to the server; and
adjusting the running total of the employee as a function of the feedback.

13. A system for determining employee compensation in a retail environment, the system comprising:
a retail check out station operated by an employee to receive data identifying at least one product to be purchased by a customer, the retail check out station including a first monitor configured to display data to the employee; and
a server in communication with the retail check out station, the server including a storage device configured to store a plurality of customer records for a loyalty program for the retail environment and a processor configured to:
receive from the retail check out station the data identifying the at least one product to be purchased by the customer,
identify details of at least one promotion stored in the storage device as a function of the data identifying the at least one product, wherein the details of each promotion include a script for the employee of the retail environment to present the promotion to the customer;
transmit the details of the at least one promotion from the server to the retail check out station for display to the employee;
receive from the retail check out station data identifying at least additional one product purchased by the customer corresponding to the at least one promotion, and
reward the employee for each additional product purchased by the customer.

14. The system of claim 13 wherein the script for the employee is displayed on the first monitor for the employee to present to the customer.

15. The system of claim 13 further comprising a script monitor in communication with the retail check out station wherein the script for the employee is displayed on the script monitor for the employee to present to the customer.

16. The system of claim 13 further comprising a customer monitor in communication with the retail check out station configured to display visual data to the customer, wherein the details of each promotion further include a product and a price and wherein the product and the price are displayed on the customer monitor.

17. The system of claim 13 wherein the details of each promotion further include a potential commission to be earned by the employee, wherein the potential commission is displayed to the employee.

18. The system of claim 17 wherein the processor on the server is further configured to store a running total of commissions earned for each employee; and
add the potential commission to the running total for the employee when each additional product is purchased by the customer.

19. The system of claim 18 wherein the storage device is configured to store at least one threshold defining a level at which the employee receives a bonus when the running total for the employee is equal to or greater than the threshold and wherein the server transmits the running total and the threshold to the retail check out station for display to the employee while the employee is working.

20. The system of claim 13 further comprising a loyalty program device scanner configured to read an identification number from a loyalty program device provided to the customer, wherein the identification number is transmitted to the server and the processor is further configured to:
retrieve a purchase history stored in the storage device corresponding to the identification number; and
identify details of at least one promotion stored in the storage device as a function of the purchase history.
